(19) United States
(12) Patent Application Publication
(10) Pub. No.: US 2024/0326752 A1
(43) Pub. Date: Oct. 3, 2024

(54) LiDAR-Reinigungssystem

(71) Applicant: Robert Bosch GmbH, Stuttgart (DE)

(72) Inventors: Janos Simonovics, Dunaharaszti (HU); Akos Hegyi, Mezöhegyes (HU); Bence Balint, Monor (HU); Gyorgy Szabo, Budapest (HU); Mate Hornyak, Pakozd (HU); Peter Deak, Budapest (HU); Zoltan Gyonyoru, Budapest (HU)

(21) Appl. No.: 18/615,420

(22) Filed: Mar. 25, 2024

(30) Foreign Application Priority Data
Mar. 27, 2023 (DE) 10 2023 202 738.0

(51) Int. Cl. B60S 1/52; B60S 1/48; B60S 1/54; B60S 1/56; G01S 7/497; G01S 17/931

(52) U.S. Cl. CPC B60S 1/524; B60S 1/488; B60S 1/546; B60S 1/566; G01S 7/497; G01S 17/931; G01S 2007/4977

(57) ABSTRACT

The present invention relates to a LiDAR cleaning system (10) comprising an actuator (12) which is configured to displace a cleaning arm (14) along a sensor surface (102) of a LiDAR sensor (100), wherein the cleaning arm (14) has at least one nozzle unit, wherein the LiDAR cleaning system is configured to clean the sensor surface (102) by displacing (18) the cleaning arm (14) and by discharging at least one fluid (20) using the nozzle unit (16).

### BACKGROUND

The present invention relates to a LiDAR cleaning system and a vehicle.

There are currently a plurality of different solutions for cleaning sensor surfaces in vehicles. Due to the increasing number of sensor surfaces to be cleaned on vehicles and the increased requirements of autonomous driving, the demand for innovative and robust cleaning methods is continuously increasing.

Steady weight reduction in the vehicle area to minimize consumption and increasing competition create cost pressure so that cheaper and more efficient components for vehicles are more in demand.

### SUMMARY

The LiDAR cleaning system according to the invention has the advantage over the known ones that the cleaning performance of the LiDAR cleaning system can be significantly increased due to cleaning with a wiper lip and a fluid. Furthermore, the discharging of the fluid can further reduce the adhesion of contamination to the sensor surface of the LiDAR sensor. Furthermore, the energy requirement of the LiDAR cleaning system can be reduced due to the increased cleaning effectiveness.

According to the invention, this is achieved by the LiDAR cleaning system having an actuator which is configured to displace a cleaning arm along a sensor surface of a LiDAR sensor. Furthermore, the cleaning arm has at least one nozzle unit. Furthermore, the LiDAR cleaning system is configured to clean the sensor surface by displacing the cleaning arm and discharging at least one fluid using the nozzle unit.

In other words, the cleaning arm of the LiDAR cleaning system has a nozzle unit which is configured to apply at least one fluid, in particular a cleaning fluid, to the sensor surface under pressure. In this way, the LiDAR cleaning system or the nozzle unit can perform a type of pressurized cleaning of the sensor surface. For example, the LiDAR cleaning system can comprise a fluid source. In particular, the fluid source can be a cleaning agent tank or a cleaning agent tank with a corresponding pump. Furthermore, the LiDAR cleaning system can have an actuator such as an electric motor. The actuator can displace or move the cleaning arm along the sensor surface of the LiDAR sensor. Furthermore, the cleaning arm comprises at least one nozzle unit configured to apply a fluid to the sensor surface. For example, the nozzle unit has a fluid channel which has a plurality of nozzle openings by means of which the fluid can emerge so that it is sprayed onto the sensor surface. Furthermore, the LiDAR cleaning system can clean the sensor surface or remove dirt from it by displacing or moving the cleaning arm and by discharging or spraying at least one fluid using the nozzle unit. The displacement of the cleaning arm and the discharge of at least one fluid using the nozzle unit can take place simultaneously or at different times. For example, the nozzle unit can discharge a spray film and then the actuator can move the cleaning arm so that the sensor surface is cleaned. Furthermore, the displacement of the cleaning arm along the sensor surface and the discharge of the fluid can take place simultaneously for the duration of the displacement, for example. It is also preferable for the fluid to be discharged using the nozzle unit for only part of the time that the cleaning arm is displaced.

The dependent claims disclose preferred embodiments of the invention.

Preferably, the cleaning arm has a first side on which at least one fluid channel is arranged, wherein the fluid channel has at least one nozzle opening which is configured to direct the at least one fluid onto the sensor surface.

An advantage of this embodiment is that a fluid can be transported from a fluid source to the cleaning arm with the aid of the fluid channel and the nozzle opening, and a discharge direction of the fluid to the sensor surface can be specifically set. Thus, the cleaning efficiency of the LiDAR cleaning system may be further increased. Furthermore, the diameter of the fluid channel can be uniform over the entire length of the fluid channel. Furthermore, the diameter of the fluid channel can change over the length of the fluid channel. For example, a diameter can decrease continuously from a fluid source of the fluid channel to an end point of the fluid channel.

Further preferably, the cleaning arm has a second side on which at least one further fluid channel is arranged, wherein the further fluid channel has at least one further nozzle opening which is configured to direct the at least one fluid onto the sensor surface, wherein a first discharge direction of the nozzle opening and a second discharge direction of the further nozzle opening are oriented substantially opposite to each other.

An advantage of this embodiment is that the amount of fluid or cleaning agent can be significantly increased, so that the cleaning efficiency of the LiDAR cleaning system can be further increased. In other words, the cleaning arm has a fluid channel on both sides, which can distribute the fluid in different application directions by means of nozzle openings. The first discharge direction and the second discharge direction can be arranged essentially parallel to the sensor surface. Furthermore, the first discharge direction and the second discharge direction are arranged in opposite directions to each other. Thus, the first discharge direction can be arranged on the first side of the cleaning arm and the second discharge direction on the second side of the cleaning arm. Thus, the first nozzle opening and the second nozzle opening are located opposite each other on the cleaning arm.

Preferably, the fluid channel and/or the further fluid channel has a plurality of nozzle openings for discharging the fluid onto the sensor surface, wherein a first subset of the plurality of nozzle openings has a first setting angle, wherein a second subset of the plurality of nozzle openings has a second setting angle.

One advantage of this embodiment is that the nozzle unit can cover a larger area of the sensor surface or clean it using the fluid thanks to the different setting angles. This further increases the efficiency of the cleaning system. For example, the first setting angle and the second setting angle can have a reference, which is arranged in particular orthogonally to the sensor surface. For example, the first setting angle and the second setting angle can be selected between 0° and 180°. Furthermore, the first setting angle can be 20°, for example, wherein the second setting angle is 70°, for example.

Preferably, the plurality of nozzle openings is arranged on the fluid channel and/or on the further fluid channel on the basis of a predetermined pattern.

An advantage of this embodiment is that the predetermined pattern can be used to align some or all of the plurality of nozzle openings to partial regions of the sensor surface that may have above-average contamination spots. Thus, the cleaning efficiency of the LiDAR cleaning system may be further improved. For example, the predetermined pattern can be selected such that a central area of the sensor surface can be cleaned by an above-average number of nozzle openings.

The fluid channel and/or the other fluid channel also preferably have at least one heating element.

One advantage of this embodiment is that the LiDAR cleaning system can also be used in application scenarios where the ambient temperature is well below 0° C. This means that the LiDAR cleaning system can be used more flexibly. For example, the heating element can be a heating wire or similar.

Further preferably, the fluid channel and/or the further fluid channel are configured to connect the fluid channel and/or the further fluid channel to a fluid source by means of an attachment of the cleaning arm to the LiDAR cleaning system.

One advantage of this embodiment is that the number of assembly steps for attaching the cleaning arm to the LiDAR cleaning system is reduced, since in particular the cleaning arm and the fluid channel and/or the further fluid channel can be attached to the LiDAR cleaning system by means of an insertion. For example, the cleaning arm can be detachably attached to the LiDAR cleaning system by means of a positive and/or non-positive connection. When establishing or releasing the positive and/or non-positive connection, the fluid channel or the further fluid channel can be released or connected to a fluid source simultaneously.

Preferably, the cleaning arm has at least one air deflection element, wherein the air deflection element is configured to deflect an air flow to assist the discharge of the fluid to the nozzle surface.

An advantage of this embodiment is that the air deflector element prevents turbulence of the fluid, so that the cleaning efficiency of the LiDAR cleaning system can be further increased. In particular, the air deflection element can direct or deflect an air flow away from a nozzle opening so that the discharge of the fluid is not obstructed by an air flow, such as airstream. The air deflector element can be formed in one piece from a plastic with the cleaning arm. Furthermore, the air deflection element can be designed as a separate component that can be mounted on the cleaning arm.

Preferably, the cleaning arm is configured to change the orientation of the air deflection element.

An advantage of this embodiment is that the orientation of the air deflection element can be changed based on an applied air flow, so that the cleaning efficiency of the LiDAR cleaning system can be further increased. For example, at a low speed of the vehicle in which the LiDAR cleaning system can be installed, the air deflection element can have a first position. At an increased speed of the vehicle in which the LiDAR cleaning system may be installed, the air deflection element may be arranged in a second position or second orientation in order to deflect an air flow from the nozzle openings while the fluid is being discharged.

Another aspect of the invention relates to a vehicle comprising a LiDAR cleaning system as described above and below.

### BRIEF DESCRIPTION OF THE DRAWINGS

Exemplary embodiments of the invention are described in detail hereinafter with reference to the accompanying drawings. The drawings show:

FIGS. 1 through 7 a LiDAR cleaning system according to one embodiment,

FIG. 8 a vehicle according to one embodiment.

### DETAILED DESCRIPTION

Preferably, all identical components, elements, and/or units are provided with the same reference symbols in all figures.

FIG. 1 shows a LiDAR cleaning system 10 according to one embodiment. The LiDAR cleaning system 10 is arranged on a LiDAR sensor 100. The LiDAR sensor 100 comprises a sensor surface 102. The LiDAR sensor 100 is configured to transmit and/or receive signals, in particular through the sensor surface 102. Furthermore, the LiDAR cleaning system 10 comprises an actuator 12. The actuator 12 is configured to displace a cleaning arm 14 along the sensor surface. Furthermore, the actuator 12 is configured to displace the cleaning arm 14 along a predetermined path 18. Furthermore, the cleaning arm 14 comprises a nozzle unit 16.

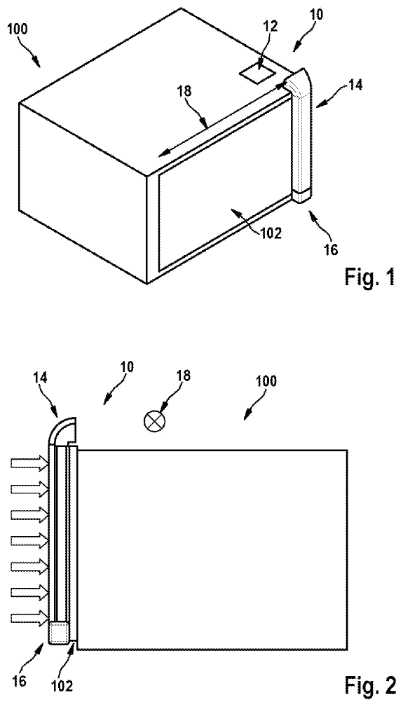

FIG. 2 shows a LiDAR cleaning system 10 according to one embodiment. The LiDAR cleaning system 10 is arranged on a LiDAR sensor 100. The LiDAR sensor 100 has a sensor surface 102 through which the LiDAR sensor 100 can send and/or receive signals. Furthermore, the LiDAR cleaning system 10 has a cleaning arm 14, which can be moved along the sensor surface 102 by means of a displacement 18.

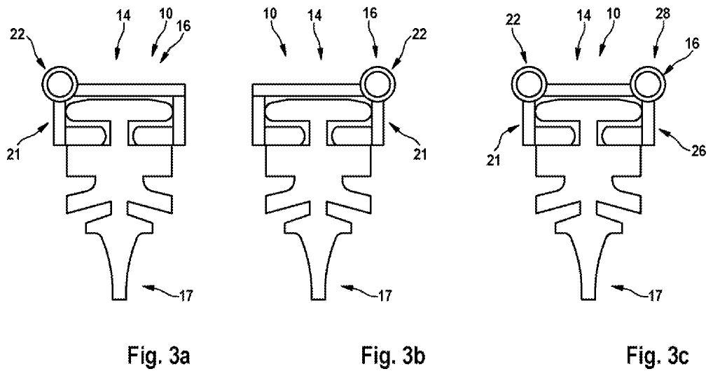

FIG. 3a shows an embodiment of the LiDAR cleaning system 10. The LiDAR cleaning system 10 also comprises a cleaning arm 14. The cleaning arm 14 has a first side 21 on which a fluid channel 22 is arranged.

FIG. 3b shows a LiDAR cleaning system 10, which comprises a nozzle unit 16. The nozzle unit 16 comprises the fluid channel 22, which is arranged on a first side 21 of the cleaning arm. Furthermore, the cleaning arm 14 comprises a wiper lip 17, which can be arranged on the cleaning arm 14 in particular with a positive and/or non-positive connection.

FIG. 3c shows a LiDAR cleaning system 10 with a cleaning arm 14. The cleaning arm 14 comprises a nozzle unit 16, which has a fluid channel 22 and a further fluid channel 28. The fluid channel 22 is arranged on a first side 21 of the cleaning arm 14. The further fluid channel 28 is arranged on a second side 26 of the cleaning arm 14. As shown in FIG. 3c, the first side 21 and the second side 26 are arranged opposite each other on the cleaning arm 14.

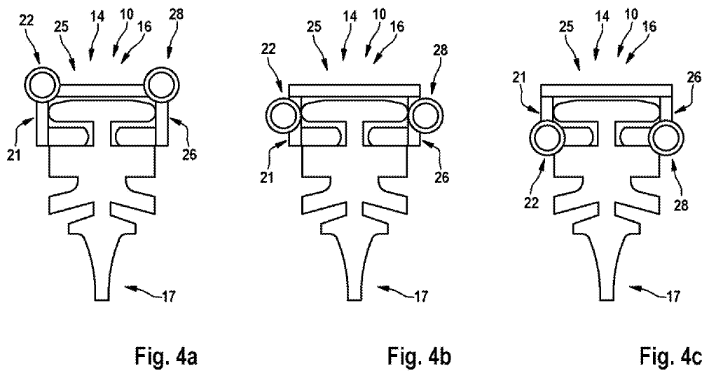

FIG. 4a shows a LiDAR cleaning system 10, which has a cleaning arm 14. The cleaning arm 14 has a housing 25. The fluid channel 22 and the further fluid channel 28 are arranged on an upper edge of the housing 25. The fluid channel 22 can be arranged on the first side 21. Furthermore, the further fluid channel 28 can be arranged on the second side 26 of the cleaning arm 14. Furthermore, a wiper lip 17 can be arranged on the cleaning arm 14, in particular by means of a positive and/or non-positive connection.

FIG. 4b shows a further possible arrangement of the fluid channel 22 and the further fluid channel 28 on the housing 25 of the cleaning arm 14 compared to FIG. 4a. Here, the fluid channel 22 and the further fluid channel 28 are arranged centrally on a lateral surface of the housing 25.

FIG. 4c shows the LiDAR cleaning system 10 with a cleaning arm 14. FIG. 4c shows a further possible arrangement of the fluid channel 22 and the further fluid channel 28 on the housing 25 of the cleaning arm 14 in comparison to FIGS. 4a and 4b. In this case, the fluid channel 22 and the further fluid channel 28 are arranged at a lateral end of the housing 25.

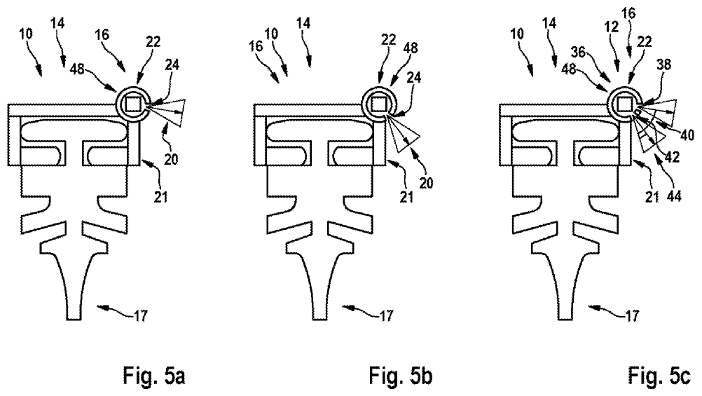

FIG. 5a shows a LiDAR cleaning system 10 with a cleaning arm 14. The cleaning arm 14 has a nozzle unit 16, which comprises a fluid channel 22. The fluid channel 22 is arranged on a first side 21 of the cleaning arm 14. Furthermore, the cleaning arm 14 comprises a wiper lip 17, which is detachably arranged on the cleaning arm 14 by means of a positive and/or non-positive connection. In particular, a heating element 48 can be arranged in the fluid channel 22. Furthermore, the fluid 20 can be defined in its discharge direction by means of a nozzle opening 24. FIG. 5a shows a discharge direction of the fluid 20 by means of the nozzle opening of approximately 70°.

FIG. 5b shows a LiDAR cleaning system 10 with a cleaning arm 14. The cleaning arm 14 comprises a nozzle unit 16. The nozzle unit 16 has a fluid channel 22 on a first side 21 of the cleaning arm 14. The fluid channel has a nozzle opening 24 which is configured to direct the fluid 20. As shown in FIG. 5b, the discharge direction of the nozzle opening 24 is approximately 20° to the perpendicular of the sensor surface 102.

FIG. 5c shows a LiDAR cleaning system 10 with a cleaning arm 14. The cleaning arm 14 comprises a nozzle unit 16. The nozzle unit 16 has a fluid channel 22, which has a plurality of nozzle openings 36. A first subset 38 of the plurality of nozzle openings 36 has a first setting angle 40. Furthermore, a second subset 42 of the plurality of nozzle openings 36 has a second setting angle 44. The first setting angle 40 and the second setting angle 44 can be determined in particular orthogonally to the sensor surface. As shown in FIG. 5c, the first setting angle 40 is approximately 70°. The second setting angle 44 is approximately 20°, as shown in FIG. 5c.

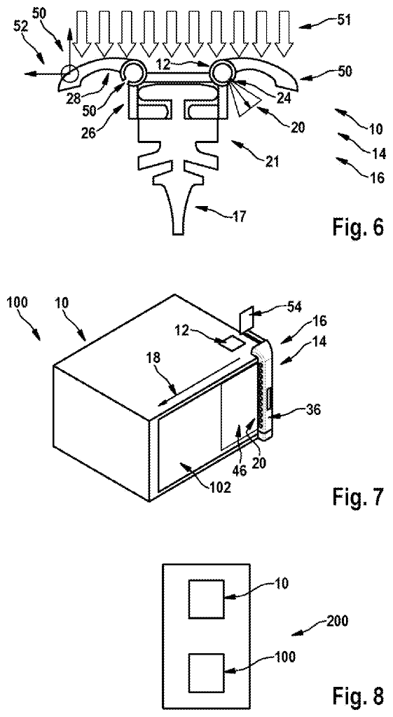

FIG. 6 shows a LiDAR cleaning system 10 with a cleaning arm 14. The cleaning arm 14 has a nozzle unit 16. The nozzle unit 16 comprises a fluid channel 22, which is arranged on a first side 21 of the cleaning arm 14. Furthermore, the nozzle unit 16 comprises a further fluid channel 28, which is arranged on a second side 26 of the cleaning arm 14. At least one nozzle opening 24 is arranged on the fluid channel 22, which is configured to discharge the fluid 20 onto the sensor surface 102. The further fluid channel 28 has a further nozzle opening 30, which is also configured to apply the fluid 20 to the sensor surface 102. Further, the cleaning arm comprises at least one air deflector element 50. Further, the cleaning arm 14 may be configured to adjust an orientation 52 of the air deflector element 50. In particular, the air deflection element 50 can deflect an air flow 51 from a sensor surface 102. Furthermore, the air deflector element 50 may in particular be configured to protect the fluid 20 discharged through the nozzle openings 24, 30 from being swirled by an air flow 51. Furthermore, the cleaning arm 14 can have an air deflector element 50 on both sides, as shown in FIG. 6.

FIG. 7 shows a LiDAR cleaning system 10, which is arranged on a LiDAR sensor 100. The LiDAR cleaning system 10 can have a fluid source 54. In particular, the fluid source 54 can be connected to a nozzle unit 16 of the cleaning arm 14 in a fluid-conducting manner. Furthermore, the LiDAR cleaning system 10 has an actuator 12, which is configured to displace the cleaning arm 14 along the sensor surface 102. Thus, the LiDAR cleaning system 10 can clean the sensor surface 102 of the LiDAR sensor 100 by means of a displacement 18 of the cleaning arm 14 and a discharge of a fluid 20. Furthermore, the nozzle unit 16 may in particular have a plurality of nozzle openings 36. The plurality of nozzle openings 36 may be configured to discharge the fluid 20 according to a predetermined pattern 46.

FIG. 8 shows a vehicle 200 which has a LiDAR cleaning system 10, as described above, and a LiDAR sensor 100.

1. A LiDAR cleaning system (10) comprising:
an actuator (12) which is configured to displace a cleaning arm (14) along a sensor surface (102) of a LiDAR sensor (100),
wherein the cleaning arm (14) has at least one nozzle unit, wherein the LiDAR cleaning system is configured to clean the sensor surface (102) by displacing (18) the cleaning arm (14) and by discharging at least one fluid (20) using the nozzle unit (16).

2. The LiDAR cleaning system (10) according to claim 1, wherein the cleaning arm (14) has a first side (21) on which at least one fluid channel (22) is arranged, wherein the fluid channel (22) has at least one nozzle opening (24) which is configured to direct the at least one fluid (20) onto the sensor surface (102).

3. The LiDAR cleaning system (10) according to claim 2, wherein the cleaning arm (14) has a second side (26) on which at least one further fluid channel (28) is arranged, wherein the further fluid channel (28) has at least one further nozzle opening (30) which is configured to direct the at least one fluid (20) onto the sensor surface (102), wherein a first discharge direction (32) of the nozzle opening (24) and a second discharge direction (34) of the further nozzle opening (30) are oriented substantially opposite to each other.

4. The LiDAR cleaning system (10) according to claim 2 wherein the fluid channel (22) and/or the further fluid channel (28) has/have a plurality of nozzle openings (36) for discharging the fluid (20) onto the sensor surface (102), wherein a first subset (38) of the plurality of nozzle openings (36) has a first setting angle (40), wherein a second subset (42) of the plurality of nozzle openings (36) has a second setting angle (44).

5. The LiDAR cleaning system (10) according to claim 4, wherein the plurality of nozzle openings (36) are arranged on the fluid channel (22) and/or the further fluid channel (28) based on a predetermined pattern (46).

6. The LiDAR cleaning system (10) according to claim 2, wherein the fluid channel (22) and/or the further fluid channel (28) have at least one heating element (48).

7. The LiDAR cleaning system (10) according to claim 2, wherein the fluid channel (22) and/or the further fluid channel (28) are configured to connect the fluid channel (22) and/or the further fluid channel (28) to a fluid source (54) by means of an attachment of the cleaning arm (14) to the LiDAR cleaning system (10).

8. The LiDAR cleaning system (10) according to claim 1, wherein the cleaning arm (14) has at least one air deflector element (50), wherein said air deflector element (50) is configured to deflect an air flow to assist the discharge of the fluid (20) onto the sensor surface (102).

9. The LiDAR cleaning system (10) according to claim 8, wherein the cleaning arm (14) is configured to change an orientation (52) of the air deflection element (50).

10. The vehicle (200) comprising a LiDAR cleaning system (10) according to claim 1.
